(19) United States
(12) Patent Application Publication
(10) Pub. No.: US 2015/0047771 A1
(43) Pub. Date: Feb. 19, 2015

(54) TIRE BUILDING MACHINE AND BOOST TURN-UP METHOD THEREOF

(71) Applicant: MESNAC Co., Ltd., Shandong (CN)

(72) Inventors: Jiguo Cheng, Shandong (CN); Shoutao Wu, Shandong (CN); Huili Yang, Shandong (CN); Mingxin Sun, Shandong (CN)

(73) Assignee: MESNAC CO., LTD., Shandong (CN)

(21) Appl. No.: 14/354,980

(22) PCT Filed: Dec. 18, 2012
(86) PCT No.: PCT/CN2012/086846

§ 371 Date: Sep. 15, 2014

(30) Foreign Application Priority Data
Dec. 22, 2011 (CN) 201110433490.0

(51) Int. Cl. B29D 30/32

(52) U.S. Cl. CPC B29D 30/32; B29D 2030/3242; B29K 2105/253
USPC 156/132; 156/400

(57) ABSTRACT

The boost turn-up method comprises a belt drum, which is carried and driven by a belt drum case, and a forming drum, which is carried and driven by a forming drum case; a first boost device, which is arranged along the axial direction, is arranged at the side part of the belt drum; a second boost device, which is arranged along the axial direction, is arranged at the side part of the forming drum; the first boost device and the second boost device are symmetrical along the vertical center line of the forming drum in the turn-up preparation process of a tire blank; the first boost device and the second boost device push the Bladder or the turn-up rods towards the center from two sides of the forming drum. Thus, the same thrust is simultaneously exerted to assist implementation of the turn-up operation.

This application claims priority under 35 U.S.C. §119(a) to Patent Application No. PCT/CN2012/086846 filed Dec. 18, 2012, which claims priority to Chinese Application No. CN 2011-10433490.0, filed Dec. 22, 2011, the entire contents of which are incorporated by reference.

### FIELD OF THE INVENTION

The present invention relates to a tire forming machine for preparing a rubber tire and a boost turn-up method thereof, and belongs to the field of rubber machinery.

### BACKGROUND OF THE INVENTION

Depending on the type of tire block, manufacturing equipment available, etc., the equipment structure for rubber tires, is generally a double-drum, triple-drum or four-drum forming machine. Differences between tire blank production technologies are determined by the differences of manufacturing equipment and methods.

In general, the forming machine needed for turn-up processing of a tire blank includes at least one belt drum for preparing a belt-tread component, and one forming drum for respectively conveying a tire component and the belt-tread component to finish laminating. Moreover, turn-up operations need to be independently arranged. In order to finish the turn-up operation of the tire blank, Bladder or finger-shaped turn-up rods at two sides are generally adopted.

The existing turn-up device leads in compressed air through an air cavity, so as to axially drive the Bladder or the finger-shaped turn-up rods sleeved on a main shaft of a forming drum. The Bladder or the finger-shaped turn-up rods extrude the tire side part from two sides of the forming drum, so as to finish the overall turn-up process.

For example, Chinese Patent Application Number 200920019931.0 illustrates a mechanical forming drum. The main disclosure is that the mechanical forming drum comprises a hollow columnar main shaft; a roller screw with left and right symmetrical threads is arranged inside the main shaft; a lock block component and a finger-shaped turn-up device are symmetrically sleeved along the outer circumference and the vertical center line of the main shaft; the finger-shaped turn-up device comprises a cylinder sliding sleeve, a cylinder body and a plurality of finger-shaped turn-up rods; the finger-shaped turn-up rods are evenly arranged along the outer circumference of the main shaft; a turn-up roller is arranged at the front end part of each turn-up rod; the rear end part of each turn-up rod is axially arranged at the rear end of the cylinder body; the roller screw is connected to the rear end of the cylinder sliding sleeve through a pin shaft and a key; the lock block component comprises a lock block cylinder body arranged at the front end of the cylinder sliding sleeve; the lock block cylinder body is connected and fastened with a tire body lock block group through a piston group and a connecting rod in the internal part.

The above technical solution is that the Bladder or the finger-shaped turn-up rods achieve turn-up by virtue of thrust of a pneumatic device. The pneumatic thrust device affects factors such as air source pressure, air cavity sealing performance and the like. The thrust exerted on two sides of the tire blank does not easily achieve synchronous and isodynamic effects, and is not easily maintained within the force value range of the design requirements for a long period of time. Moreover, the pressure exerted on the tire side part is unstable and unbalanced in distribution, so that air bubbles are easily preserved in the tire, so as to affect the subsequent processing quality and safe use of the tire blank.

### INVENTION CONTENT

The tire forming machine and a boost turn-up method described herein aims at solving the problems of the existing prior art. A, mechanical boost turn-up method and device are adopted; in which axial thrust is provided to the Bladder or the turn-up rods through mechanical boost devices at two sides of the forming drum simultaneous, isodynamic and persistent manners. Thus, the Bladder or the turn-up rods are assisted to finish the overall turn-up process, so as to achieve a turn-up operation with stable and evenly distributed pressure, and improve the tire blank forming quality.

Another advantage of the invention is that equal thrust at two sides and equal distances can be achieved, and variable and controllable thrust, variable and controllable speed, and variable and controllable position in the turn-up process also can be achieved.

Yet another advantage of the invention is that air supply and delivery line designs of the existing forming machine and forming drum can be simplified, and design and use of related components are reduced. Thus, the overall manufacturing cost of the forming machine is reduced, and the forming technology is optimized.

Additional features and advantages of the invention will be set forth in the description that follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the invention, as embodied and broadly described, the present invention provides a boost turn-up method of a tire forming machine, the forming machine comprising a belt drum, a belt drum case, a forming drum, a forming drum case, a first boost device arranged along an axial direction at a first side part of the belt drum, a second boost device arranged along the axial direction at a second side part of the forming drum, wherein the first boost device and the second boost device are symmetrical along a vertical center line of the forming drum in a turn-up preparation process of the tire, the method comprising carrying and driving a belt drum by a belt drum case; carrying and driving the belt drum by the belt drum case; simultaneously pushing, by the first and second boost devices, Bladder or turn-up rods towards a center from the respective first and second side parts of the forming drum, thus exerting simultaneous identical thrust.

In another embodiment, the boost turn-up method of the tire forming machine further comprises carrying the belt drum case on a bottom slide rail; sliding the belt drum case in a reciprocating manner along a horizontal direction under a drive of a slide rail drive device; and carrying, by the belt drum case, the first boost device to slide to one side of the forming drum before a boost turn-up operation is carried out, wherein the first boost device and the second boost device are symmetrical along a vertical center line of the forming drum.

In yet another embodiment, the boost turn-up method of the tire forming machine further comprises carrying the forming drum case on the bottom slide rail, wherein the forming drum case can slide in a reciprocating manner along a horizontal direction under the drive of the slide rail drive device; and carrying, by the belt drum case, the first boost device and carrying, by the forming drum case, the second boost device such that the first boost device and the second boost device slide opposite before the boost turn-up operation is along the vertical center line of the forming drum.

Another embodiment of the boost turn-up method is the tire forming machine, wherein annular boost plates capable of extending outside along the axial directions are respectively arranged at end parts of the first boost device and the second boost device.

In another embodiment, the boost turn-up method of the tire forming machine, wherein a sliding shaft is sleeved on an inner diameter of a main shaft of the belt drum case, the annular boost plates are arranged at an outer side end of the sliding shaft, a group of axial drive devices being connected to an inner side end of the sliding shaft, so as to exert lateral boost thrust on the annular boost plates by axial sliding shift of the sliding shaft.

In another embodiment, a tire forming machine, comprises a belt drum carried and driven by a belt drum case; a forming drum carried and driven by a forming drum case; and a first boost device arranged along an axial direction at a side part of the belt drum, wherein the first boost device is capable of pushing a capsule or a turn-up rod at one side of the forming drum along the axial direction under a drive of an axial drive device; and a second boost device arranged along the axial direction at a side part of the forming drum, wherein the second boost device is capable of pushing a capsule or a turn-up rod at an other side of the forming drum along the axial direction under the drive of the axial drive device.

Another embodiment of the present invention is the tire forming machine, wherein the belt drum case is carried on a bottom slide rail, and is capable of sliding in a reciprocating manner along the horizontal direction under the drive of a slide rail drive device.

In another embodiment, in the tire forming machine, the forming drum case is carried on a bottom slide rail, and is capable of sliding in a reciprocating manner along a horizontal direction under the drive of a slide rail drive device.

In yet another embodiment, in the tire forming machine, annual boost plates capable of extending outside along the axial directions are respectively arranged at end parts of the first boost device and the second boost device.

Another embodiment of the tire forming machine, further comprises a sliding shaft that is sleeved on an inner diameter of a main shaft of the belt drum case, the boost plates being arranged at the outer side end of the sliding shaft; an inner side end of the sliding shaft being fixedly connected with a slide saddle, the slide saddle being simultaneously sleeved on ball screws at two sides; driven pulleys being arranged at the end parts of the ball screws; a driving pulley being sleeved on an output end of a gear motor; and a synchronous belt being connected between the driving pulley and the driven pulleys.

Accordingly, in the present invention, by adopting the mechanical boost turn-up method and device, the axial thrust is provided to the Bladder or the turn-up rods in simultaneous, isodynamic and persistent manners, the operation with stable and evenly distributed pressure is achieved in the overall turn-up process, the tire blank forming quality is relatively high, and the probability that the air bubbles are preserved between the composite layers are effectively reduced.

Moreover, pneumatic drive and delivery line designs of the existing forming machine can be simplified and related components are reduced. Thus, the overall manufacturing cost of the forming machine is reduced, and the forming technology is optimized.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates the tire forming machine for achieving the boost turn-up method according to an embodiment of the present invention;

FIG. 2 illustrates the tire forming machine achieving mechanical boost according to an embodiment of the present invention;

FIG. 3 is a structural diagram of the belt drum case according to an embodiment of the present invention; and

FIG. 4 is a longitudinal cross-section diagram of FIG. 3.

### DETAILED DESCRIPTION OF THE PREFERRED EMBODIMENTS

Reference will now be made in detail to the preferred embodiments of the present invention, examples of which are illustrated in the accompanying drawings.

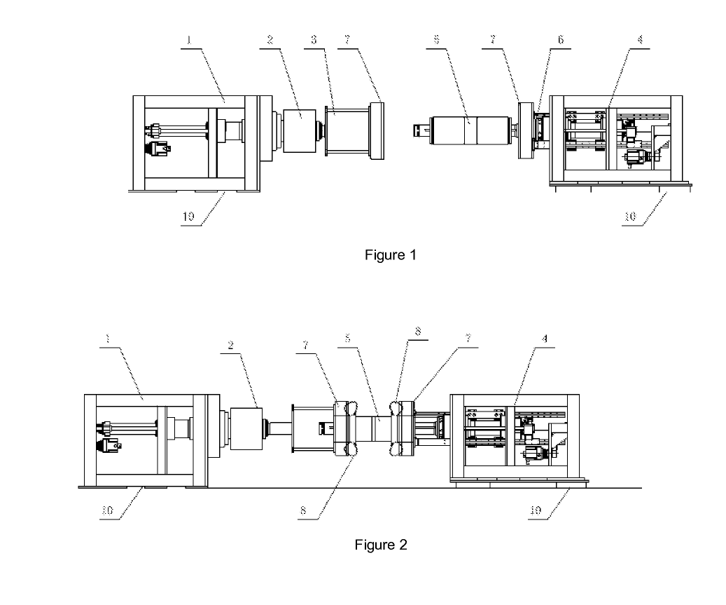

As shown in the FIGS. 1-4, preferred embodiments of the present invention comprises at least a belt drum case 1, a belt drum 2, a first boost device 3, a forming drum case 4, a forming drum 5, a second boost device 6, boost plates 7, Bladder 8, a slide rail 10, a main shaft 11, a sliding shaft 12, a slide saddle 13, ball screws 14, driven pulleys 15, a gear motor 16, a driving pulley 17, and a synchronous belt 18.

In one preferred embodiment, as shown in the FIG. 1, the tire forming machine mainly comprises a belt drum 2, which is carried and driven by a belt drum case 1, and a forming drum 5, which is carried and driven by a forming drum case 4.

The belt drum case 1 is carried on the bottom slide rail 10, and can slide in a reciprocating manner along the horizontal direction under the drive of the slide rail drive device.

The forming drum case 4 is carried on the bottom slide rail 10, and can slide in a reciprocating manner along the horizontal direction under the drive of the slide rail drive device.

As shown in FIG. 2, the first boost device 3, which is arranged along the axial direction, is arranged at the side part of the belt drum 2. The first boost device 3 can push the capsule 8 at one side of the forming drum 5 along the axial direction under the drive of the axial drive device.

The second boost device 6, which is arranged along the axial direction, is arranged at the side part of the forming drum 5. The second boost device 6 can push the capsule 8 at the other side of the forming drum 5 along the axial direction under the drive of the axial drive device.

The annular boost plates 7 are capable of extending outside along the axial directions, and are respectively arranged at the end parts of the first boost device 3 and the second boost device 6.

The same structures of axial drive devices can be adopted in the belt drum case 1 and the forming drum case 4.

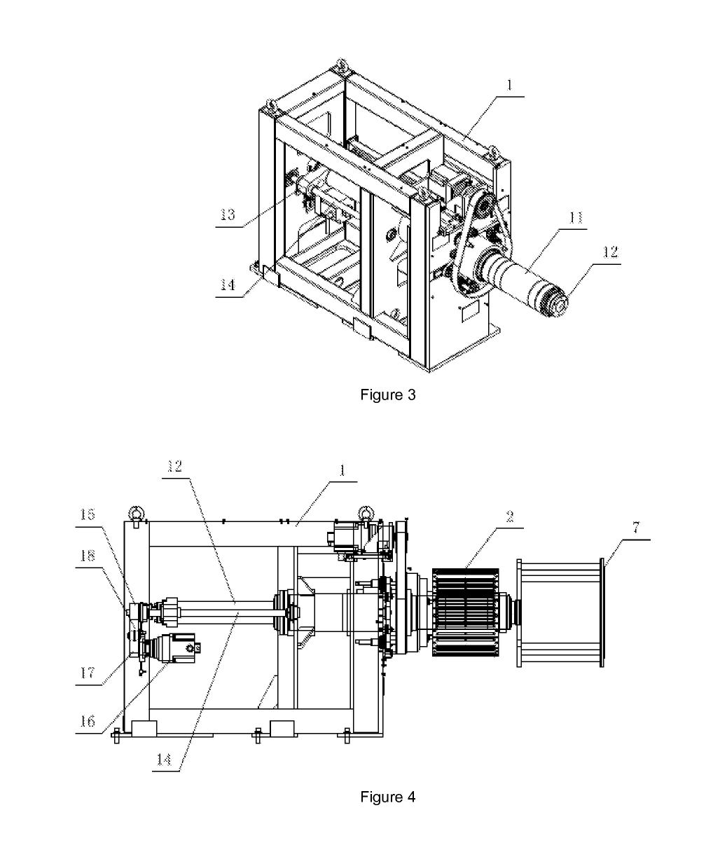

As shown in FIG. 3, in the belt drum case 1, the horizontal sliding shaft 12 is sleeved on the inner diameter of the main shaft 11 of the belt drum case 1. As shown in FIG. 4, the boost plates 7 are arranged at the outer side end of the sliding shaft 12, and the inner side end of the sliding shaft 12 is fixedly connected with the slide saddle 13. The slide saddle 13 is simultaneously sleeved on the ball screws 14 at two sides, and the driven pulleys 15 are arranged at the end parts of the ball screws 14.

The driving pulley 17 is sleeved on the output end of the gear motor 16, and the synchronous belt 18 is connected between the driving pulley 17 and the driven pulleys 15.

The boost turn-up method for the tire forming machine comprises the following steps. The belt drum case 1 is carried on the bottom slide rail 10, and can slide in a reciprocating manner along the horizontal direction under the drive of the slide rail drive device.

The forming drum case 4 is carried on the bottom slide rail 10, and can slide in a reciprocating manner along the horizontal direction under the drive of the slide rail drive device.

The belt drum case 1 and the forming drum case 4 respectively carry the first boost device 3 and the second boost device 6 to axially slide an opposite distance before the boost turn-up operation is carried out, so that the first boost device 3 and the second boost device 6 move synchronously along the vertical center line of the forming drum 5.

The first boost device 3 and the second boost device 6 move synchronously along the vertical center line of the forming drum 5 in the turn-up preparation process of the tire, and push the Bladder 8 from the center to two sides of the forming drum 5, so that the same thrust is simultaneously exerted to assist implementation of the turn-up operation.

In the boost turn-up method, the annular boost plates 7 are capable of extending outside along the axial directions and are used for axially pushing the Bladder 8 respectively arranged at the end parts of the first boost device 3 and the second boost device 6.

The sliding shaft 12 in the belt drum case 1 is sleeved on the inner diameter of the main shaft 11 of the belt drum case. The boost plates 7 are arranged at the outer side end of the sliding shaft 12 and the inner side end of the sliding shaft 12 is connected with a group of axial drive devices, so as to exert lateral boost thrust on the boost plates 7 by axial sliding shift of the sliding shaft 12.

Accordingly, the forming machine comprises a belt drum, which is carried and driven by a belt drum case, and a forming drum which is carried and driven by a forming drum case. Unlike the prior art, the present invention comprises a first boost device, which is arranged along the axial direction, is arranged at the side part of the belt drum, and a second boost device which is arranged along the axial direction, is arranged at the side part of the forming drum. The first boost device and the second boost device are symmetrical along the vertical center line of the forming drum in the turn-up preparation process of the tire blank. The first boost device and the second boost device push Bladder or turn-up rods toward the center from two sides of the forming drum. Thus, the same thrust is simultaneously exerted to assist implementation of a turn-up operation.

Accordingly, the first boost device and the second boost device provide mechanical boost thrust to the Bladder or the turn-up rods in the axial movement process. The characteristics of the mechanical boost thrust allow that controllable and adjustable thrust can be simultaneously exerted, and the time of exerting the thrust also can be accurately controlled and adjusted.

The Bladder or the turn-up rods can exert the stable and evenly distributed pressure from the tire side to the crown part in simultaneous and isodynamic manners under the mechanical boost action. Therefore, air bubbles cannot be easily preserved between composite layers, and the overall turn-up operation is high in quality.

In addition, the existing forming drum is mainly divided into a mechanical mode (namely using the turn-up rods) and a capsule mode (namely using the Bladder). The maintenance cost is reduced, and the utilization rate of equipment is improved when the mechanical forming drum adopts the turn-up rods to carry out the turn-up operation while the Bladder used by the capsule drums need to be frequently replaced, so that the labor intensity is higher, and the maintenance cost and time are more. But a few of mechanical forming drums are adopted at present, and are mainly limited by large stretching and deep indentations of the turn-up rods on the tire side.

The boost turn-up method for the tire forming machine disclosed by the present invention can be simultaneously applicable to the mechanical forming drums and the capsule drums. Accurate control on the force size, the speed and the position in the turn-up process can be carried out through the controllable boost devices according to the difference of tire blank specifications, the difference of sizing materials of the tire side and the difference of the technological requirements.

The present invention eliminates a complicated structure of the main machine of the forming machine, large axial length, long distance between the belt drum case and the first boost device, and the like. Thus, maintaining stable mechanical boost thrust is facilitated. For example, the belt drum case is carried on a bottom slide rail, and can slide in a reciprocating manner along the horizontal direction under the drive of a slide rail drive device. The belt drum case carries the first boost device to slide to one side of the forming drum before the boost turn-up operation is carried out, so that the first boost device and the second boost device are symmetrical along the vertical center line of the forming drum. Specifically, the belt drum case drives the first boost device to slide to the waiting workstation before the boost turn-up operation, and then axially drives the first boost device and the second boost device to push the Bladder or the turn-up rods in simultaneous and isodynamic manners.

The improvement scheme of the present invention comprises two modes. One, the forming drum case also oppositely drives the second boost device to slide to the waiting workstation before the boost turn-up operation when the belt drum case axially slides; and two, the forming drum case adopts the fixed mounting mode, namely the initial position of the second boost device is at the waiting workstation before the boost turn-up operation.

Similarly, the present invention reduces the waiting time that the belt drum case axially moves to the boost workstation. This is accomplished by the present invention because the forming drum case is carried on the bottom slide rail, and can slide in a reciprocating manner along the horizontal direction under the drive of the slide rail drive device. Moreover, the forming drum case carries the second boost device (no matter the belt drum case carries the first boost device to axially move or not) to axially slide before the boost turn-up operation is carried out, so that the first boost device and the second boost device are symmetrical along the vertical center line of the forming drum.

The present invention provides further improvements in that the belt drum case adopts the fixed mounting mode, namely the initial position of the first boost device is at the waiting workstation before the boost turn-up operation, and the forming drum case axially slides to convey the second boost device to the waiting workstation before the boost turn-up operation. Also, the belt drum case and the forming drum case axially slide, so as to convey the first boost device and the second boost to the symmetrical waiting workstations.

In order to further improve the balance of the exerted turn-up pressure, another embodiment of the present invention provides that annular boost plates capable of extending outside along the axial directions can be respectively arranged at the end parts of the first boost device and the second boost device, the boost plates push the Bladder or the turn-up rods upwards from the sides.

The same axial drive devices are adopted in the belt drum case and the forming drum case to provide the mechanical boost thrust exerted by the first boost device and the second boost device.

Certainly, different structures of boost plate tools adapted to the capsule turn-up mode and the mechanical turn-up mode need to be arranged correspondingly to the mechanical forming drums and the capsule drums, as will be known to those skilled in the art.

The relatively reliable scheme for the drive devices comprises that a sliding shaft is sleeved on the inner diameter of a main shaft of the belt drum case, the boost plates are arranged at the outer side end of the sliding shaft, and a group of axial drive devices are connected to the inner side end of the sliding shaft, so as to exert lateral boost thrust on the boost plates by axial sliding shift of the sliding shaft.

On the basis of the design concept of the invention, by adopting the boost turn-up method, improvement of the tire forming machine structure can be achieved as follows. Namely the tire forming machine mainly comprises the belt drum, which is carried and driven by the belt drum case, and the forming drum which is carried and driven by the forming drum case.

In the present invention, the first boost device, which is arranged along the axial direction, is arranged at the side part of the belt drum. The first boost device can push the capsule or the turn-up rod at one side of the forming drum along the axial direction under the drive of the axial drive device. The second boost device, which is arranged along the axial direction, is arranged at the side part of the forming drum, the second boost device can push a capsule or a turn-up rod at the other side of the forming drum along the axial direction under the drive of the axial drive device.

The belt drum case is carried on the bottom slide rail, and can slide in a reciprocating manner along the horizontal direction under the drive of a slide rail drive device. The forming drum case further can be carried on the bottom slide rail, and can slide in a reciprocating manner along the horizontal direction under the drive of the slide rail drive device. In addition, the annular boost plates capable of extending outside along the axial directions are respectively arranged at the end parts of the first boost device and the second boost device.

It will be apparent to those skilled in the art of tire building machines and a boost turn-up method that various modifications and variations can be made of the present invention without departing from the spirit or scope of the invention. Thus, it is intended that the present invention covers the modifications and variations of this invention provided they come within the scope of the appended claims and their equivalents.

1. A boost turn-up method of a tire forming machine, the forming machine comprising a belt drum, a belt drum case, a forming drum, a forming drum case; a first boost device arranged along an axial direction at a first side part of the belt drum, a second boost device arranged along the axial direction at a second side part of the forming drum, wherein the first boost device and the second boost device are symmetrical along a vertical center line of the forming drum in a turn-up preparation process of the tire; the method comprising:
carrying and driving a belt drum by a belt drum case;
carrying and driving the belt drum by the belt drum case;
simultaneously pushing, by the first and second boost devices, Bladder or turn-up rods towards a center from the respective first and second side parts of the forming drum, thus exerting simultaneous identical thrust.

2. The boost turn-up method of the tire forming machine according to claim 1, further comprising:
carrying the belt drum case on a bottom slide rail;
sliding the belt drum case in a reciprocating manner along a horizontal direction under a drive of a slide rail drive device;
carrying, by the belt drum case, the first boost device to slide to one side of the forming drum before the boost turn-up operation is carried out, wherein the first boost device and the second boost device are symmetrical along a vertical center line of the forming drum.

3. The boost turn-up method of the tire forming machine according to claim 2, further comprising:
carrying the forming drum case on the bottom slide rail, wherein the forming drum case can slide in a reciprocating manner along a horizontal direction under the drive of the slide rail drive device;
carrying, by the belt drum case, the first boost device and carrying, by the forming drum case, the second boost device such that the first boost device and the second boost device slide opposite before the boost turn-up operation is along the vertical center line of the forming drum.

4. The boost turn-up method of the tire forming machine according to claim 3, wherein annular boost plates capable of extending outside along the axial directions are respectively arranged at end parts of the first boost device and the second boost device.

5. The boost turn-up method of the tire forming machine according to claim 4, wherein a sliding shaft is sleeved on the inner diameter of a main shaft of the belt drum case, the annular boost plates are arranged at an outer side end of the sliding shaft, a group of axial drive devices being connected to an inner side end of the sliding shaft, so as to exert lateral boost thrust on the annular boost plates by axial sliding shift of the sliding shaft.

6. A tire forming machine, comprising
a belt drum carried and driven by a belt drum case,
a forming drum carried and driven by a forming drum case;
a first boost device arranged along an axial direction at a side part of the belt drum; wherein the first boost device is capable of pushing a capsule or a turn-up rod at one side of the forming drum along a axial direction under a drive of an axial drive device;
a second boost device arranged along the axial direction at a side part of the forming drum, wherein the second boost device is capable of pushing a capsule or a turn-up rod at an other side of the forming drum along the axial direction under the drive of the axial drive device.

7. The tire forming machine according to claim 6, wherein the belt drum case is carried on a bottom slide rail, and is capable of sliding in a reciprocating manner along the horizontal direction under the drive of a slide rail drive device.

8. The tire forming machine according to claim 6, wherein the forming drum case is carried on a bottom slide rail, and is capable of sliding in a reciprocating manner along a horizontal direction under the drive of the slide rail drive device.

9. The tire forming machine according to claim 8, wherein annual boost plates capable of extending outside along the axial directions are respectively arranged end parts of the first boost device and the second boost device.

10. The tire forming machine according to claim 9, further comprising a sliding shaft that is sleeved on an inner diameter of a main shaft of the belt drum case, the boost plates being arranged at the outer side end of the sliding shaft; an inner side end of the sliding shaft being fixedly connected with a slide saddle, the slide saddle being simultaneously sleeved on ball screws at two sides;
driven pulleys being arranged at the end parts of the ball screws;
a driving pulley being sleeved on an output end of a gear motor (16); and
a synchronous belt being connected between the driving pulley and the driven pulleys.
